(19) United States
(12) Patent Application Publication
(10) Pub. No.: US 2010/0033707 A1
(43) Pub. Date: Feb. 11, 2010

(54) DEVICE AND METHOD FOR THREE-DIMENSIONAL FLOW MEASUREMENT

(76) Inventors: Christof Gerlach, Unterhaching (DE); Michael Zielinski, Unterschleissheim (DE)

Correspondence Address: GREER, BURNS & CRAIN, 300 S WACKER DR, 25TH FLOOR, CHICAGO, IL, 60606, US

(21) Appl. No.: 12/440,843

(22) PCT Filed: Sep. 7, 2007
(86) PCT No.: PCT/DE07/01619

§ 371 Date: Mar. 11, 2009

(30) Foreign Application Priority Data
Sep. 15, 2006 (DE) 10-2006-043-445.5

(51) Int. Cl. G01P 5/20; G01P 3/36

(52) U.S. Cl. 356/28; 73/861.05

(57) ABSTRACT

A method for repairing turbine blades by replacing at least a part of the blade profile, the method having: a) manufacture of a replacement blade part; b) separation of the damaged area with a standardized cutting plane, leaving behind a remaining blade; c) matching of the replacement blade part to the actual geometry of the remaining blade; d) connecting or joining of the replacement blade part to the remaining blade by soldering of at least one web and welding of an outer contour.

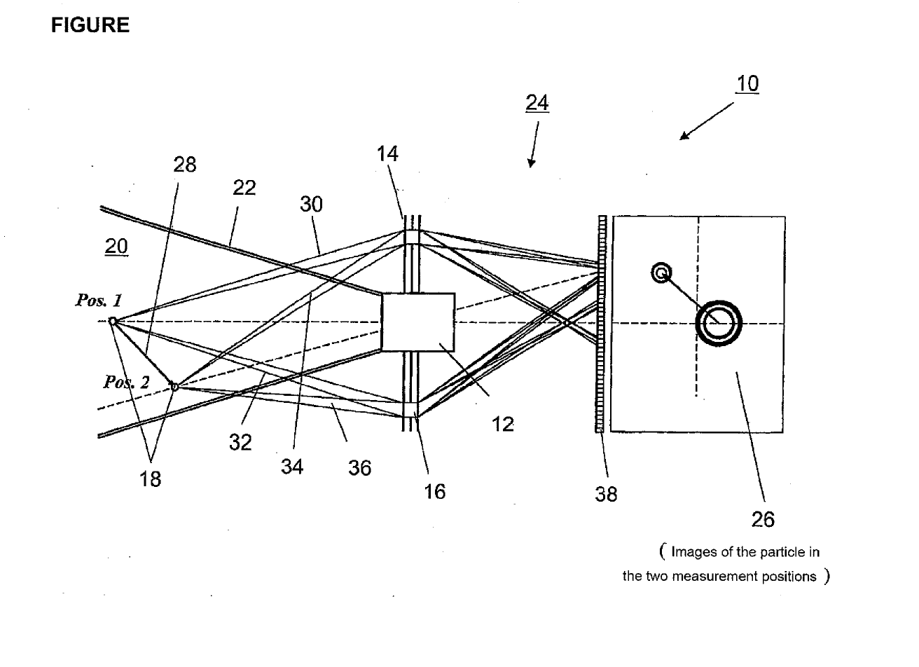

The present invention relates to a device for three-dimensional flow measurement, in particular for carrying out particle image velocimetry (PIV) measurements, having at least one illumination device for illuminating tracer particles moving in a measuring volume of the flow that is to be examined, and having at least one camera for repeated reproduction of the moving tracer particles. In addition, the present invention relates to a method for three-dimensional flow measurement, in particular for carrying out particle image velocimetry (PIV) measurements.

Particle image velocimetry (PIV) is an optically operating velocity measurement method with the aid of which two components of the spatial velocity field in an illuminated measurement plane can be acquired. The principle of PIV is based on the observation of small tracer particles that are added to a flowing fluid or gas, or are already contained therein. Two light pulses are used to expose the tracer particles, and the scattered light is recorded in analog fashion on a photographic film or digitally on a charge-coupled (CCD) storage matrix. The analog or digitized pictures are then subsequently further processed using image processing programs in order to obtain the velocity information. By observing the flow field from different angles of view, it is also possible to record spatial velocity information using PIV. Here, special mirror arrangements or two cameras are used to acquire the displacement of the particles normal to a light section plane. Examples of this are described in DE 103 12 696 B3 and in DE 199 28 698 A1. WO 03/017000 A1 also describes a device and a method for carrying out three-dimensional PIV measurements. There the device comprises at least two cameras, each having an objective in front of which is situated a diaphragm having three holes. Each of the observed and reproduced tracer particles thus supplies three points whose distance and situation are correlated with the distance of the tracer particles from the focus plane of the respective camera.

However, a disadvantage of these known devices is that they require a large apparatus outlay and considerable optical accessibility for a three-dimensional flow measurement.

In addition, devices for three-dimensional flow measurement are known that use probes. However, a disadvantage of these devices is that the probes extend into the flow and therefore disturb it.

Therefore, the object of the present invention is to provide a device for three-dimensional flow measurement, in particular for carrying out particle image velocimetry (PIV) measurements of the type named above, that ensures a rapid and contactless measurement without disturbing the flow, with a relatively small instrumental outlay.

The object of the present invention is also to provide a method of this type for three-dimensional flow measurement, in particular for carrying out particle image velocimetry (PIV) measurements, that ensures a rapid and contactless measurement without disturbing the flow, with a relatively small instrumental outlay.

These objects are achieved by a device according to the features of Claim 1 and by a method according to the features of Claim 16.

Advantageous constructions of the present invention are described in the respective subclaims.

A device according to the present invention for three-dimensional flow measurement, in particular for carrying out particle image velocimetry (PIV) measurements, comprises at least one illumination device for illuminating tracer particles moving in a measuring volume of the flow that is to be examined, and at least one camera for repeated reproduction of the moving tracer particles. According to the present invention, the camera has at least one objective having a ring diaphragm situated in front of it or on it. Based on the PIV, the spatial movement components are obtained through the use of at least one objective in which only an outer ring gap of the lenses is used. The tracer particles appear in the reproduction as rings or ring segments having a diameter that is a function of the distance from the focus plane of the camera. Together with the displacement of the individual tracer particles in a predetermined time period for the determination of a velocity vector, this results in three-dimensional spatially distributed flow information that can be obtained in contactless fashion, i.e. without disturbing the flow, and with a small instrumental outlay. Thus, advantageously, only one camera and one illumination device are required in order to determine the data. In addition, a simple window in the housing of the components being examined is sufficient to enable determination of the planar three-dimensional flow curves. In addition, it is fundamentally not necessary for the device to have an illumination device having a subsequently connected light section optical system for the illumination of a light section with light coming from the illumination device. Finally, in addition very rapid measurements are possible, so that corresponding measurement sessions can be carried out more often, and at the same time with higher spatial resolution, than can be achieved using known methods. In further constructions of the device according to the present invention, however, the light section optical system may be present. It is also possible for the device to have a second illumination device having a subsequently connected light section optical system for illuminating a light section with light coming from the second illumination device. A light section optical system may be advantageous in particular if the separation of the tracer particle images in the area around the focus plane is not sufficient against the out-of-focus foreground or background.

In a preferred specific embodiment, the objective has a chromatic aberration. This simplifies the measurement, because the colors of the rings or ring segments supply information as to whether the tracer particles are situated in front of or behind the focus plane of the camera. Because the radius of the rings or ring segments of tracer particles situated close to the focus plane of the camera is close to zero, from the colors it is easy to determine whether the tracer particles are moving toward the focus plane or away from it.

In an alternative specific embodiment, a prism can also be used in the beam path. In this way, the rings or ring segments of tracer particles situated in the focus plane have a radius greater than zero. In this way, the information concerning the movement toward or away from the focus plane can be read in simplified fashion directly from the radius.

The prism, which is fashioned in particular as a ring prism, can be attached in front of or behind the ring diaphragm. Moreover, it is possible to use for this purpose an objective having prism properties; in particular, it is possible to exploit the lens errors of the objective.

In an advantageous construction of the present invention, the camera is a CCD camera having at least one CCD chip, or is a CMOS camera. Through the digitized recording of the tracer particle images, a precise and simple further processing is possible using image processing programs. In addition, the digitized data can be stored in a corresponding storage unit and processed at a later time.

In another advantageous construction of the present invention, the illumination device is situated in the area of the optical axis of the objective, in particular in a central area of the objective. This advantageously results in a small construction of the device for three-dimensional flow measurement according to the present invention.

In another advantageous construction of the device according to the present invention, the illumination device emits broadband light or light having different spectral regions. In the case of illumination with for example two colors (e.g. red and blue), an evaluation takes place of the color-separated rings or ring segments. In the case of broadband illumination, an evaluation of the color smearing takes place.

In another advantageous construction of the present invention, the illumination device has at least one laser light source. This may be for example a Nd:YAG laser. The laser can emit pulsed light impulses. Additional illumination sources, such as flashbulbs, LEDs, or the like, may also be used. Advantageously, these illumination sources also emit pulsed light. In addition, it is possible, for rotating components, to synchronize the illumination or light pulses with the rotational speed of the component, so that each pulse takes place exactly at the predetermined measurement position of the component.

In further advantageous constructions of the devices according to the present invention, a movement of the focus plane of the camera takes place through a movable construction of the camera, the construction of the objective as a zoom objective, and/or through an electrical modification of the lens properties and thus of the focal lengths of the objective. The latter is required only in the ring gap.

In further advantageous constructions of the device according to the present invention, the camera is a double-image color camera. With the use of a prism, it is possible for the device to have at least one black-and-white camera. Because in this case no color information has to be evaluated, this is sufficient, and is correspondingly more convenient. Moreover, the resolution of the black-and-white camera is higher. The black-and-white camera can be fashioned as a double-image black-and-white camera.

In further advantageous constructions of the present invention, the tracer particles are made to be fluorescent. This results in a back-reflection of the individual tracer particles in a range having a larger wavelength relative to the wavelength of the illumination. Using corresponding filters, in this way it is possible to carry out a background suppression, resulting in increased evaluation precision. Background suppression is also possible through a darkening of the components that are to be examined. In addition, it is possible to use mirrored, non-mirrored, or black-colored hollow balls, or balls filled with fluorescent dye, as tracer particles. Mirrored hollow balls are used here in combination with a darkened background, and black hollow balls are used in combination with a bright, reflective background. In the last-named exemplary embodiment, a negative measurement takes place directly in front of the background surfaces, such that the tracer particles stand out as dark in front of the brighter background. Here, the reflection color, which reflects more strongly in the direction of the source of illumination, is used for the precise detection of the particles.

In another advantageous construction of the device according to the present invention, the device has an evaluation unit for evaluating the images of the tracer particles recorded by the camera, and for calculating and presenting a temporally defined three-dimensional flow curve of the tracer particles in the measuring volume. Thus, for example using suitable algorithms the recorded images can be mathematically evaluated in order to determine the displacement of the tracer particles between the temporally successive exposures. Special filtering algorithms can also be used for the detection and evaluation of the rings or ring segments in the images. Given use of a non-telecentric objective, the rings or ring segments of particles situated outside the focus plane of the camera are deformed in oval fashion. This deformation can be corrected by an equalization carried out by computer.

A method according to the present invention for three-dimensional flow measurement, in particular for carrying out particle image velocimetry (PIV) measurements, comprises the following method steps: a) illumination of tracer particles situated in a measuring volume with at least one illumination device; b) recording and reproduction of at least two temporally successive images of the tracer particles, the image recording taking place using at least one camera and the camera having at least one objective having a ring diaphragm situated in front of it or on it, so that the tracer particles are reproduced as rings or ring segments; c) comparison of the recorded images with respect to the displacement of the individual tracer particles in a predefined time period in order to determine a velocity vector of the respective tracer particle, as well as acquisition of the diameter of the individual annularly reproduced tracer particles in order to determine the distance of the respective tracer particle from the focus plane of the camera, in order to determine the relative position of the respective tracer particle to the focus plane of the camera, and d) calculation of a three-dimensional velocity vector of the tracer particles in the measuring volume through evaluation of the data and information obtained in method step c).

Advantageously, the method according to the present invention yields three-dimensional flow information that is spatially distributed and is obtained without contact, i.e. without disturbing the flow. In addition, in comparison with known methods only a very small instrumental outlay is necessary. The calculation of the three-dimensional velocity vectors takes place by evaluating all the information contained in the recorded images, as determined and acquired in method step c). Through the representation of the tracer particles as rings or ring segments, their position and diameter can be determined very precisely and unambiguously. This holds also for the case in which only parts of a ring are visible. In addition, the ring gap or ring diaphragm integrally lets more light through the objective than the point diaphragm having three holes known from the prior art.

The method according to the present invention is based on the use of a PIV method in which the spatial movement components are used through the use of the objective having a ring diaphragm situated in front of it or on it, and the simultaneous exploitation of the chromatic aberration of the lenses of the objective. The reproduced tracer particles appear as rings or ring segments whose diameter is a function of the distance of the tracer particles from the focus plane of the camera.

In a preferred specific embodiment, an objective having chromatic aberration is used. The colors supplied in this way of the rings or ring segments supply information concerning whether the associated tracer particles are situated in front of or behind the focus plane of the camera. This greatly simplifies the determination of the velocity sector, because from the colors it can be determined whether the tracer particles are moving toward the focus plane or away from it.

Alternatively, a prism can also be used in the beam path, or prismatic properties of the objective, in particular lens errors, may be exploited. In this way, the rings or ring segments of the tracer particles in the focus plane of the camera are represented with a radius greater than zero. From the change in size, the direction of movement can easily be determined depending on whether the radius is becoming larger or becoming smaller.

In an advantageous construction of the method according to the present invention, the illumination of the tracer particles takes place using at least two. successive light pulses, or through a single temporally lengthened light pulse. Here the illumination device can emit broadband light or light having different spectral regions. Here, given illumination with two different colors (e.g. red and blue), an evaluation of the color-separated rings or ring segments takes place. Given a broadband illumination, an evaluation takes place of the color smearing in the rings or ring segments. The illumination device here can comprise at least one laser light source. For example, a pulsed Nd:YAG laser may be used. Additional sources of illumination, such as flashbulbs, LEDs, or the like, may also be used. These sources of illumination advantageously also emit pulsed light.

In further advantageous constructions of the method according to the present invention, the time period between two successive light pulses is capable of being controlled in such a way that an adaptation takes place to the currently prevailing flow conditions, in particular flow velocities. The controlling of the light pulse sequence can be carried out automatically. In addition, it is possible for rotating components to synchronize the illumination or light pulses with the rotational speed of the component, so that each pulse takes place exactly at the predetermined measurement position of the component.

In further advantageous constructions of the method according to the present invention, the camera is a CCD camera having at least one CCD chip, or is a CMOS camera. Here, the recording and reproduction of at least two temporally successive images of the tracer particles according to method step b) can take place in digitized fashion. The evaluation of the images according to method step c) is standardly carried out using an image processing program. Here, special filtering algorithms can be used for the detection and evaluation of the rings or ring segments in the images. Finally, the calculation of the three-dimensional velocity vector of the tracer particles takes place using corresponding evaluation software in a suitable data processing system. Given the use of a non-telecentric objective, the rings or ring segments of particles situated outside the focus plane of the camera are deformed in oval fashion. This deformation can be corrected by an equalization carried out by computer.

In another advantageous construction of a method according to the present invention, the illumination device has a subsequently connected light section optical system for illuminating a light section with light coming from the illumination device. However, it is also possible that a second illumination device be fashioned that has a correspondingly subsequently connected light section optical system for illuminating a light section with light coming from the second illumination device. The use of such a light section optical system takes place in the cases in which a separation of the tracer particle images in the area around the focus plane of the camera is not sufficient against the out-of-focus foreground or background.

In further advantageous constructions of the method according to the present invention, the focus plane of the camera is capable of being modified. This can take place through a movable construction of the camera itself, or the objective can be fashioned as a zoom objective, and/or the tens properties of the objective, and thus its focal length, can be electrically modifiable.

In another advantageous construction of the method according to the present invention, the tracer particles are made fluorescent. This results in a background suppression that leads to a significant improvement in measurement precision. In addition, mirrored, non-mirrored, or black-colored hollow balls, or hollow balls filled with fluorescent dye, can be used as tracer particles. Here, mirrored hollow balls are used in combination with a darkened background, and black hollow balls are used in combination with a brighter, reflecting background. In the last-named exemplary embodiment, a negative measurement takes place directly in front of the background surfaces, such that the tracer particles stand out as dark in front of the brighter background. Here, the reflection color, which reflects more strongly in the direction of the source of illumination, is used for the precise detection of the particles.

In another advantageous construction of the method according to the present invention, the method comprises the recording of at least one image of the measuring volume without tracer particles, and the comparison of this image, or the image data, with an image, or the data of an image, with tracer particles. Through the recording and comparison of the images with and without tracer particles, it is possible to suppress a background noise through difference formation, thus increasing the image quality and the quality of the resulting data.

The device and the method according to the present invention are used for example in the measurement of flow conditions in aircraft engines or engine components, in particular in compressors and turbines.

Further advantages, features, and details of the present invention result from the following description of an exemplary embodiment, shown in the drawing.

The FIGURE shows, in highly schematized fashion, a device 10 for three-dimensional flow measurement, in particular for carrying out particle image velocimetry (PIV) measurements. Device 10 comprises an illumination device 12 for illuminating tracer particles 18 moving in a measuring volume 20 of the flow being examined. In addition, device 10 comprises a camera 24 for repeated reproduction of the moving tracer particles 18. It will be seen that camera 24 has an objective 14 having a ring diaphragm 16. Here, illumination device 12 is situated in a central area of objective 14. In the depicted exemplary embodiment, illumination device 12 is a two-color flashbulb.

Upon actuation of illumination device 12, measurement volume 20 or tracer particles 18 are illuminated in the area of a cone of rays 22. The light back-scattered by tracer particles 18 is recorded and reproduced via objective 14 having ring diaphragm 16, on a CCD chip 38 of camera 24, fashioned as a CCD camera. A corresponding reproduction of tracer particle 18 in two different positions (Pos. 1, Pos. 2) is shown in image 26 of the FIGURE. It will be seen that tracer particle 18 is shown as a ring in two different positions. Image 26 represents a recording of tracer particle 18 in temporally different measurement positions within measuring volume 20. Within a predefined time span between the two image exposures of camera 24, tracer particle 18 moves from Pos. 1 to Pos. 2, along arrow 28. Arrow 28 represents the direction of movement of tracer particle 18. This displacement can be seen clearly in image 26. Through the diameter of the reproduced tracer particle 18, which is shown as larger in Pos. 2 compared to Pos. 1, the distance of the tracer particle relative to the focus plane of camera 24 can be determined unambiguously. In the depicted exemplary embodiment, tracer particle 18 in its position 2 is closer to the focus plane of camera 24 than in position 1.

After the determination of the position and diameter of the rings or ring segments in image 26, there takes place a correlation of the exposures of tracer particles 18 in the different measurement positions, Finally, the evaluation of the colors of the rings yields information as to whether tracer particle 18 is situated in front of or behind the focus plane of camera 24. In order to obtain the last-named item of information, device 10 makes use of the chromatic aberration of the lenses of objective 14. Here, the illumination of tracer particles 18 can take place here with two colors and a corresponding evaluation of the color-separated rings, or through a broadband illumination and corresponding evaluation of the color smearing.

Device 10 additionally comprises an evaluation unit (not shown) for evaluating the images 26, recorded by camera 24, of tracer particles 18, and for calculating and representing a temporally defined three-dimensional flow curve of all tracer particles 18 in measuring volume 20. This is based on the information contained in images 26, in particular the position of the rings, their diameter, and their color distribution.

Alternatively, a prism (not shown) may also be used, so that the information concerning the movement of tracer particles 18 toward the focus plane or away from it may be taken directly from the change in size. In this case as well, only one black-and-white camera would then be necessary, and the otherwise standard color camera would be omitted.

In addition, the FIGURE shows beam path 30, 32, 32, 34 of the light reflected by tracer particle 18 in Pos, 1 and Pos. 2.

In the depicted exemplary embodiment, the recording and reproduction of the at least two successive images 26 of tracer particles 18 are digitized. The evaluation of images 26 is accomplished using an image processing program, and the calculation of the three-dimensional velocity vector of tracer particles 18 is accomplished using corresponding evaluation software of the evaluation unit. The evaluation unit is standardly a computer or a data processing system.

1. A device for three-dimensional flow measurement, in particular for carrying out particle image velocimetry (PIV) measurements, comprising: at least one illumination device for illuminating tracer particles moving in a measuring volume of the flow being examined, and having at least one camera for the repeated reproduction of the moving tracer particles, wherein the camera has at least one objective and a ring diaphragm situated in front of it or on it.

2. The device as recited in claim 1, characterized in that the objective has a chromatic aberration.

3. The device as recited in claim 1, characterized in that the prism, or a corresponding filter, is situated before and/or after the ring diaphragm in the beam path.

4. The device as recited in claim 3, characterized in that the prism is a ring prism.

5. The device as recited in claim 3, characterized in that an objective having prism properties is used.

6. The device as recited in claim 1, characterized in that the camera is a CCD camera having at least one CCD chip, or is a CMOS camera.

7. The device as recited in claim 1, characterized in that the illumination device is situated in the area of the optical axis of the objective.

8. The device as recited in claim 7, characterized in that the illumination device is situated in a central area of the objective.

9. The device as recited in claim 1, characterized in that the illumination device has a subsequently connected light section optical system for illuminating a light section with light coming from the illumination device.

10. The device as recited in claim 1, characterized in that the device has a second illumination device having a subsequently connected light section optical system for illuminating a light section with light coming from the second illumination device.

11. The device as recited in claim 1, characterized in that the illumination device emits broadband light or light having different spectral regions.

12. The device as recited in claim 1, characterized in that the illumination device comprises at least one laser light source.

13. The device as recited in claim 1, characterized in that the camera is fashioned so as to be movable.

14. The device as recited in claim 1, characterized in that the camera is a double-image color camera.

15. The device as recited in claim 3, characterized in that the device has at least one black-and-white camera.

16. The device as recited in claim 15, characterized in that the black-and-white camera is fashioned as a double-image black-and-white camera.

17. The device as recited in claim 1, characterized in that the objective is a zoom objective.

18. The device as recited in claim 1, characterized in that the lens properties of the objective are electrically modifiable.

19. The device as recited in claim 1, characterized in that the tracer particles are made fluorescent.

20. The device as recited in claim 1, characterized in that the device has an evaluation unit for evaluating the images, recorded by the camera, of the tracer particles, and for calculating and representing a temporally defined, three-dimensional flow curve of the tracer particles in the measuring volume.

21. A method for three-dimensional flow measurement, in particular for carrying out particle image velocimetry (PIV) measurements, comprising the following method steps:
a) illumination of tracer particles situated in a measuring volume, using at least one illumination device;
b) recording and reproduction of at least two temporally successive images of the tracer particles, the image recording taking place using at least one cameras, and the camera having at least one objective and having a ring diaphragms situated in front of it or on it, so that the tracer particles are reproduced as rings or ring segments;
c) comparison of the recorded images with respect to the displacement of the individual tracer particles in a predefined time span for the determination of a velocity vector of the respective tracer particles, as well as acquisition of the diameter of the individual annularly reproduced tracer particles in order to determine the distance of the respective tracer particles from the focus plane of the camera, in order to determine the relative position of the respective tracer particles from the focus plane of the camera; and
d) calculation of a three-dimensional velocity vector of the tracer particles in the measuring volume by evaluating the data and information obtained in method step c).

22. The method as recited in claim 21, characterized in that an objective is used having a chromatic aberration in order to determine the colors of the individual annularly reproduced tracer particles.

23. The method as recited in claim 21, characterized in that in addition a prism, in particular a ring prism, is brought into the beam path.

24. The method as recited in claim 21, characterized in that the illumination of the tracer particles takes place using at least two successive light pulses, or a single, temporally lengthened light pulse.

25. The method as recited in claim 24, characterized in that the time span between two successive light pulses is controllable in such a way that an adaptation takes place to the respectively prevailing flow conditions, in particular flow velocities.

26. The method as recited in claim 21, characterized in that the camera is a CCD camera having at least one CCD chip, or is a CMOS camera.

27. The method as recited in claim 21, characterized in that the recording and reproduction of at least two temporally successive images of the tracer particles according to method step b) takes place in digitized fashion.

28. The method as recited in claim 21, characterized in that the evaluation of the images according to method step c) takes place using an image processing program.

29. The method as recited in claim 21, characterized in that the calculation of a three-dimensional velocity vector of the tracer particles takes place using corresponding evaluation software.

30. The method as recited in claim 21, characterized in that the illumination device emits broadband light or light having different spectral regions.

31. The method as recited in claim 21, characterized in that the illumination device comprises at least one laser light source.

32. The method as recited in claim 21, characterized in that the illumination device has a subsequently connected light section optical system for illuminating a light section with light coming from the illumination device.

33. The method as recited in claim 21, characterized in that a second illumination device is provided having a subsequently connected light section optical system for illuminating a light section with light coming from the second illumination device.

34. The method as recited in claim 21, characterized in that the camera is fashioned so as to be movable.

35. The method as recited in claim 21, characterized in that the objective is a zoom objective.

36. The method as recited in claim 21, characterized in that the lens properties of the objective are electrically modifiable.

37. The method as recited in claim 21, characterized in that the tracer particles are made fluorescent.

38. The method as recited in claim 21, characterized in that the method comprises the recording of at least one image of the measuring volume without tracer particles and the comparison of this image, or the image data, to an image, or to the data of an image, with tracer particles.

39. The use of a device or of a method according to claim 21 for measuring the flow conditions in aircraft engines or engine components, in particular in compressors and turbines.
